(19) United States
(12) Patent Application Publication
(10) Pub. No.: US 2003/0208575 A1
(43) Pub. Date: Nov. 6, 2003

(54) Framework for e-service management

(76) Inventors: Earl D. Cox, Chapel Hill, NC (US); Franco R. Negri, Columbia, MD (US); Todd Materazzi, Columbia, MD (US); Jason Bragg, Winter Park, FL (US); Michael E. Cormier, West Hartford, CT (US)

Correspondence Address: MCKENNA LONG & ALDRIDGE LLP, 1900 K STREET, NW, WASHINGTON, DC, 20006, US

(21) Appl. No.: 10/035,657

(22) Filed: Oct. 26, 2001

Related U.S. Application Data
(60) Provisional application No. 60/243,401, filed on Oct. 27, 2000.

(51) Int. Cl. G06F 15/173

(52) U.S. Cl. 709/223

(57) ABSTRACT

An eService management framework is described that ensures quality of eService based on both the knowledge about the business process model of an e-service and the knowledge about the infrastructure that supports the e-service. In this framework, multiple local service management systems are deployed, each of which manages a part of the infrastructure to ensure the performance of a local system and then reports corresponding performance status of each local system to a dispatcher. Based on the performance status information routed through the dispatcher stored in the global data repository by the local service management systems, a global eService management ensures the quality of the eService by managing the infrastructure based on the business process model of the eService.

### APPLICATION DATA

Five utility patent applications are being filed simultaneously that relate to various aspects of eService management. The five utility applications are entitled “The eService Business Model”, “Framework for eService Management”, “Behavior Experts in eService Management”, “The Uniform Data Model”, and “Adaptive Feedback Control in eService Management”. The subject matter of each is hereby incorporated by reference into each of the others.

The instant utility patent application claims the benefit of the filing date of Oct. 27, 2000 of earlier pending provisional application No. 60/243,401 under 35 U.S.C. 119(e).

### RESERVATION OF COPYRIGHT

This patent document contains information subject to copyright protection. The copyright owner has no objection to the facsimile reproduction by anyone of the patent document or the patent, as it appears in the U.S. Patent and Trademark Office files or records but otherwise reserves all copyright rights whatsoever.

### BACKGROUND

1. Field of the Invention

Aspects of the present invention relate to e-commerce. Other aspects of the present invention relate to intelligently manage a business infrastructure that supports an e-service.

2. General Background and Related Art

The expanding use of the World-Wide Web (WWW) for business continues to accelerate and virtual corporations are becoming more commonplace. Many new businesses, born in this Internet Age, do not employ traditional concepts of physical site location (bricks and mortar), on-hand inventories and direct customer contact. Many traditional businesses, who want to survive the Internet revolution are rapidly reorganizing (or re-inventing) themselves into web-centric enterprises. In today's high-speed Business-to-Business (B2B) and Business-to-Customer (B2C) eBusiness environment, a corporation must provide high quality service, scale to accommodate exploding demand and be flexible enough to rapidly respond to market changes.

The growth of eBusiness is being driven by fundamental economic changes. Firms that harness the Internet as the backbone of their business are enjoying tremendous market share gains—mostly at the expense of the unenlightened that remain true to yesterday's business models. Whether it is rapid expansion into new markets, driving down cost structures, or beating competitors to market, there are fundamental advantages to eBusiness that cannot be replicated in the “brick and mortar” world.

This fundamental economic shift, driven by the tremendous opportunity to capture new markets and expand existing market share, is not without great risks. If a customer cannot buy goods and services quickly, cleanly, and confidently from one supplier, a simple search will divulge a host of other companies providing the same goods and services. Competition is always a click away.

eBusinesses are rapidly stretching their enterprises across the globe, connecting new products to new marketplaces and new ways of doing business. These emerging eMarketplaces fuse suppliers, partners and consumers as well as infrastructure and application outsourcers into a powerful but often intangible Virtual Enterprise. The infrastructure supporting the new breed of virtual corporations has become exponentially more complex—and, in ways unforeseen just a short while ago, unmanageable by even the most advanced of today's tools. The dynamic and shifting nature of complex business relationships and dependencies is not only particularly difficult to understand (and, hence manage) but even a partial outage among just a handful of dependencies can be catastrophic to an eBusiness' survival.

Businesses are racing to deploy Internet enabled services in order to gain competitive advantage and realize the many benefits of eBusiness. For an eBusiness, time-to-value is so critical that often these business services are brought on-line without the ability to manage or sustain the service. eBusinesses have been ravaged with catastrophe after catastrophe. Adequate technology, to effectively prevent these catastrophes, does not exist.

eBusiness infrastructures operate around the clock, around the globe, and constantly evolving. If a critical supplier in Asia cannot process an electronic order due to infrastructure problems, the entire supply chain comes to a grinding halt. Who understands the relationships between technology and business processes and between producer and supplier? Are they available 24×7×365? How long will it take to find the right person and rectify the problem? The promise of B2B, B2C and eCommerce in general will not be fully realized until technology is viewed in light of business process to solve these problems.

Web-enabled eBusiness processes effectively distill all computing resources down to a single customer-visible service (or eService). For example, a user interacts with a web site to make an on-line purchase. All of the back-end hardware and software components supporting this service are hidden, so the user's perception of the entire organization is based on this single point of interaction. How can organizations mitigate these risks and gain the benefits of well-managed eServices?

Never before has an organization been so dependent on a single point of service delivery—the eService. An organization's reputation and brand depend on the quality of eService delivery because, to the outside world, the eService is the organization. If service delivery is unreliable, the organization is perceived as unreliable. If the eService is slow or unresponsive, the company is perceived as being slow or unresponsive. If the Service is down, the organization might as well be out of business.

Further complicating matters, more and more corporations are outsourcing all or part of their web-based business portals. While reducing capital and personnel costs and increasing scalability and flexibility, this makes Application Service Providers (ASPs), Internet Service Providers (ISPs) and Managed Service Providers (MSPs) the custodians of a corporation's business. These “xSPs” face similar challenges—delivering quality service in a rapid, cost efficient manner with the added complication of doing so across a broad array of clients. Their ability to meet Service Level Agreements (SLAs) is crucial to the eBusiness developing a respected, high quality electronic brand—the equivalent of prime storefront property in a traditional brick and mortar business.

The Internet enables companies to outsource those areas in which the company does not specialize. This collaboration strategy creates a loss of control over infrastructure and business processes between companies comprising the complete value chain. Partners, including suppliers and service providers must work in concert to provide a high quality service. But how does a company control infrastructure which it doesn't own and processes that transcend its' organizational boundaries? Even infrastructure outsourcers don't have mature tools or the capability to manage across organizational boundaries.

The underlying problem is not lack of resources, but the misguided attempt to apply yesterday's management technology to today's eService problem. As noted by Forrester Research, “Most companies use ‘systems’ management tools to solve pressing operational problems. None of these tools can directly map a system or service failure to business impact.” To compensate, they rely on slow, manual deployment by expensive and hard-to-find technical personnel to diagnose the impact of infrastructure failures on service delivery (or, conversely, to explain service failures in terms of events in the underlying infrastructure). The result is very long time-to-value and an unresponsive support infrastructure. In an extremely competitive marketplace, the resulting service degradation and excessive costs can be fatal.

### BRIEF DESCRIPTION OF THE DRAWINGS

The present invention is further described in the detailed description which follows, by reference to the noted drawings by way of non-limiting exemplary embodiments, in which like reference numerals represent similar parts throughout the several views of the drawings, and wherein:

FIG. 1 shows a high level block diagram of an embodiment of the present invention, in which an eService management system is dictated by the business process model of the underlying eService;

FIG. 2 is a flowchart of an eService management system;

FIG. 3 illustrates a hierarchy of an eService infrastructure;

FIG. 4 is a block diagram of a local service management system in relation to a dispatcher;

FIG. 5 shows a Behavior eXpert (BeX) with a special function as a black box with input and output;

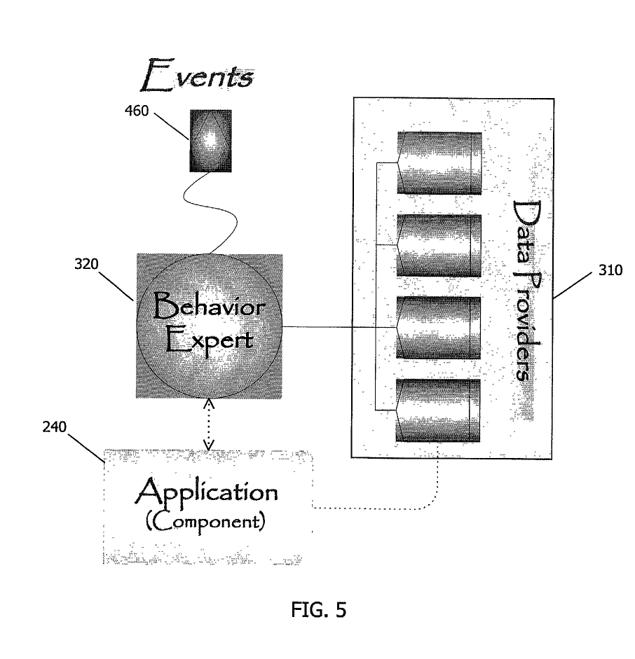

FIG. 6 illustrates in more detail the internal construction of a BeX and its relationship with other parts of a local service management system;

FIG. 7 shows how individual BeXs interact with each other and how integration BeX detects local ecological events based on isolated abnormal events;

FIG. 8 shows an exemplary flowchart of a local service management system;

FIG. 9 shows a high level block diagram of a global eService management system in relation to a dispatcher;

FIG. 10 illustrates how BeXs at different levels aggregate abnormal behavior of an eService infrastructure to reach an estimate of the overall performance of an eService;

FIG. 11 shows how a BeX is created or updated and then inserted as an executable BeX into a local service management system;

FIG. 12 illustrates an exemplary scheme in which adaptive feedback control can be realized in an eService management system;

FIG. 13 shows how information flows when adaptive feedback control in active; and

FIG. 14 illustrates adaptive feedback control.

### DETAILED DESCRIPTION

An eService management framework is described below that is consistent with the principles of the present invention and addresses the need identified above. The framework incorporates eService business process model and comprises local service management systems and global eService management systems that are all dictated by the eService business model to ensure eService delivery.

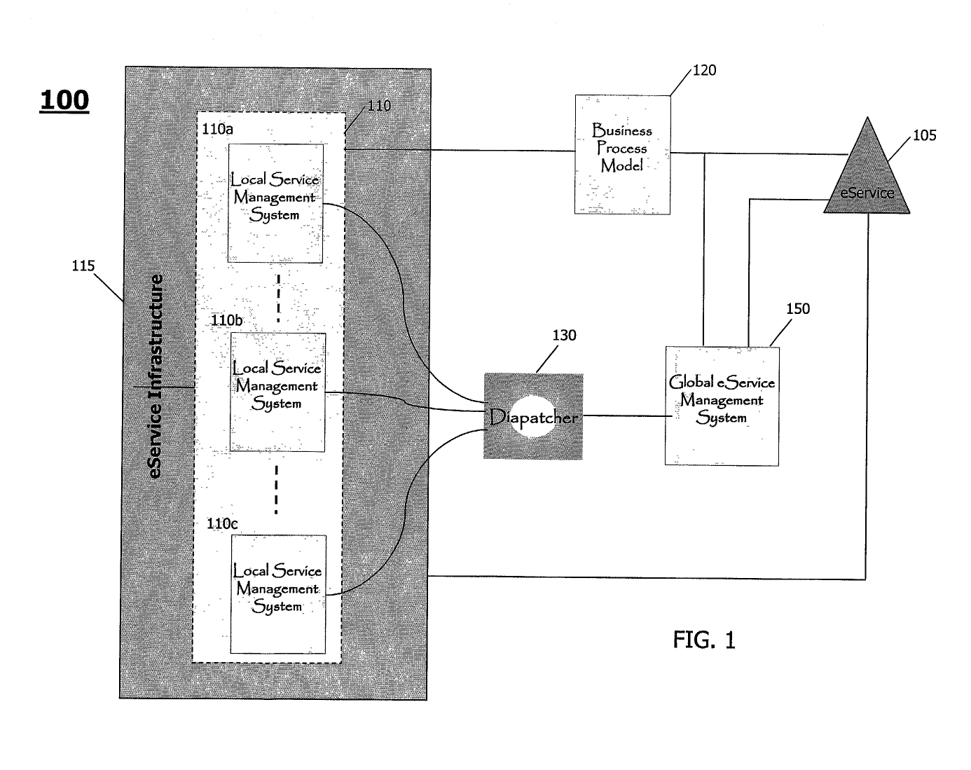

FIG.1 shows a high level diagram of an eService Management System 100. eService 105 is a web-centric service which allows electronic transactions over the Internet. Such web-centric service may, for example sell books, shoes, or flowers. It may also sell stocks or information. eService 105 is supported by eService infrastructure 115 which may comprise infrastructure components such as web servers, databases, billing systems, or other eServices. In infrastructure 115, each component plays a distinct role. For example, for a shoes.com eService that sells shoes, a database may be part of the infrastructure that stores all the transaction information. The performance of each infrastructure component may affect the overall quality of service of shoes.com eService.

In FIG. 1, there is a cluster, 110, of local management systems. Each of the local service management systems may be responsible for the management of an infrastructure component in 115. For example, local service management system 110b may be used to monitor the performance of a database for shoes.com. The performance information about the components of an eService infrastructure may be routed through a dispatcher 130 from which a global eService management system 150 may integrate the information from local service management systems 110 to assess the overall performance of the eService. Dispatcher 130 may represent a collective that comprises one or more dispatchers.

The quality of an eService depends on various factors. Such factors are related to both the performance of individual infrastructure components and how the business process of the eService takes place within the infrastructure. Different components may impact the quality of eService differently, depending on the role of the component with respect to the business process. Therefore, the strategy to manage the infrastructure that supports an eService is directly related to or dictated by the business process model of the eService. In FIG. 1, business process model 120 is derived from eService 105. It dictates both how the infrastructure components should be managed by local service management systems 110 and how global eService management system integrates the information from systems 110 to assess the overall performance of infrastructure 115. The knowledge about business process model 120 may be distributed in local service management systems 110a, 110b, . . . , 110c.

There may be multiple global eService management systems. Different global eService management systems may be responsible for different eServices but they may share local service management systems. Therefore, while global eService management system 150 may seem to be a centralized unit in system 100, it may also be distributed, similar to local service management systems.

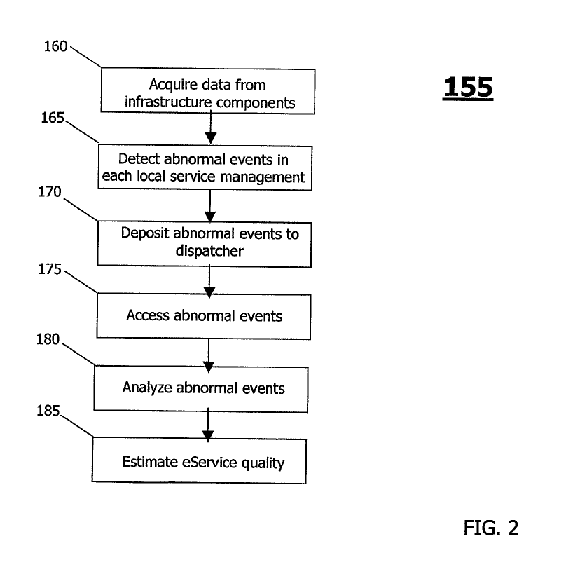

FIG. 2 shows an exemplary flowchart for system 100. To manage infrastructure components, local service management systems acquire observations related to the operational status of various components at act 160. Based on the observation data, each local service management system detects abnormal behavior or events at act 165. Detected abnormal events are then routed through dispatcher 130 at act 170. The events are then accessed at act 175 by global eService management system 150 to analyze the overall performance of infrastructure 115 at act 180. Such analysis may include estimating how each reported abnormal event impact the eService based on business process model 120. Global eService management system may also display performance information on a graphical user interface to alarm poor performance. Based on the analysis, global eService management system 150 estimate, at act 185, the quality of the underlying eService by translating infrastructure performance (both the performance of local infrastructure and the estimated overall performance) to a measure such as 90%.

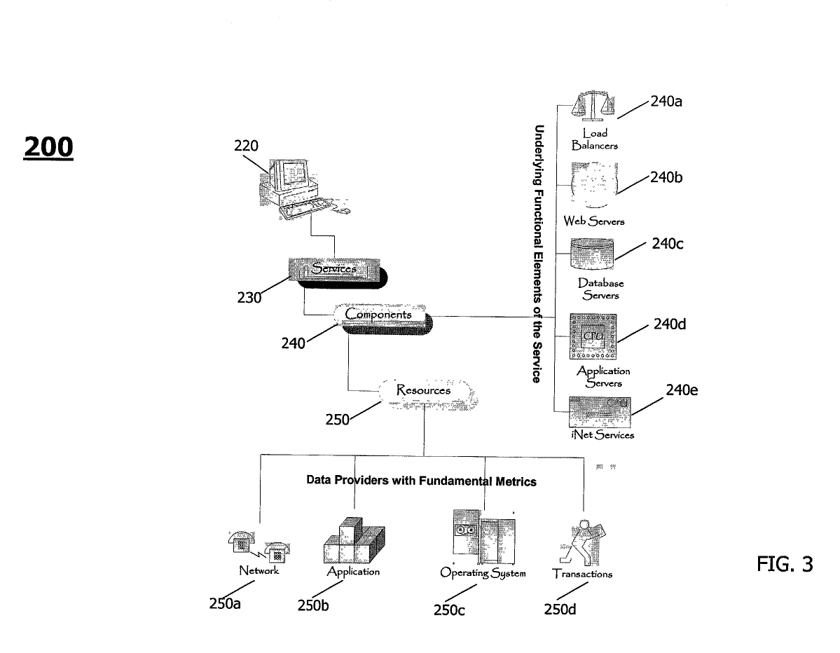

FIG. 3 shows an exemplary organization of different levels of an eService infrastructure. eService level visual observation and management station 220 is where the eService management is visualized. The levels below that are services 230, components 240 and resources 250.

Services are the highest points in eService management. They represent the actual managed deliverables. A service represents such managed delivery point as an outsourced SAP inventory system, the Yahoo Messenger, or any my.com service. These eServices reside at the top of the business-modeling pyramid.

Components are the bricks and mortar underlying an eService (and can be shared among many different eServices). They are roughly divided into two classes: high and low level components. High level components include web servers, application servers, and database servers (as well as their associated services). The low level components include load balancers, firewalls, internal network connections, and iNet Services (SMTP, DNS, Proxy, etc). From the eService management vantage point, it is the component level elements that comprise the underlying manageable building blocks in the system. By observing and (if possible) tuning the components, we identify and trace operational faults as well as optimize the performance of the eService itself.

Resources comprise the pool of “things” a component needs to survive and flourish. Resources are coupled to behavior metrics. These include such classes as the application metric (instrumentation of the component itself), the operating system, the internal network, and the transaction throughput rate. If a component has an infinite amount of resources in all these classes, it can, conceivably, run in its optimal or supraoptimal mode. But in the real world, of course, resources are shared among other service components, a server only has a finite amount of memory, disk space, and CPU cycles, and service level agreements are often set at unrealistic levels. It is at the component's resource level, that eService management places its most powerful suite of performancebased technologies. The consumption, management, and availability of critical resources are tracked through a Behavior eXpert (called a BeX). When a component becomes resource starved, the behavior expert—actually a sophisticated expert system with its own knowledge base of behavior rules and metrics—detects the situation and notifies eService management. If this condition cannot be repaired or if its constitutes an emerging pattern, then the eService Visualization facility highlights the root fault point and propagates the fault throughout the affected components and service(s).

FIG. 3 shows a high level block diagram of a local service management system 110a. Data providers 310 acquires observation data from various infrastructure components. The acquired observation data is sent to local service manager 330. A set of Behavior eXperts (Bexs) 320 access the observation data from local service manager 330. Each BeX is responsible for one or more infrastructure components and detects any abnormal behavior or events during the operation of the components. Detected abnormal events may be shared among BeXs to perform forward or backward reasoning. Those events are also sent to a local ecology pattern detector 340. While individual BeXs detect isolated abnormal events from individual components, local ecology patter detector identifies abnormal patterns in a local system environment. For example, a local computer system for maintaining shoe inventory may comprise an operating system, a database, and a software application that maintains the inventory database. In this local system, three BeXs may be deployed to monitor the performance of the operating system, the database, and the application. When the application has a fatal error during the operation, its BeX reports associated abnormal events to local ecology pattern detector. If the database fatal error recovers fast enough (does not persist), the ecology pattern detector may not generate any abnormal ecological event. If such a fatal error continues for an intolerable amount of time, local ecology pattern detector may issue an abnormal ecological event and send to dispatcher 130. Another possible scenario is that when two of the three component in this example both are reportedly experiencing abnormal behavior, ecology pattern detector may also generate an abnormal ecological event.

Sending abnormal behavior information to dispatcher 130 is through a communication unit 360. Communication unit 360 may be a gateway that sends and receives information to and from various destinations and sources, through the dispatcher 130, and then on to BeXs in other local systems or global eService management system 150.

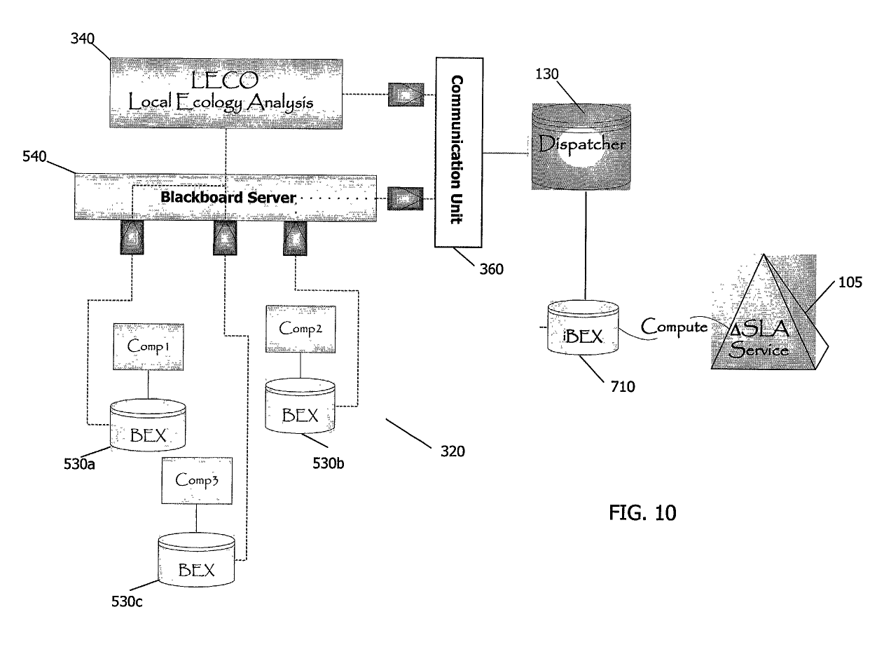

In each local service management system, adapter 350 dynamically tunes the BeXs according to adaptive feedback. For example, a BeX reports an abnormal event to ecology pattern detector as a minor abnormality but it turns out that this particular abnormality eventually causes drastic overall eService performance degradation. In this case, based on the fact that overall performance is severely affected, it is desirable to adjust the BeX so that next time, it will be more sensitive to this type of behavior. The adjustment may be done by revising the rules in this BeX. This issue is discussed later in referring to FIGS. 10 to 12 in the context of the entire eService management system.

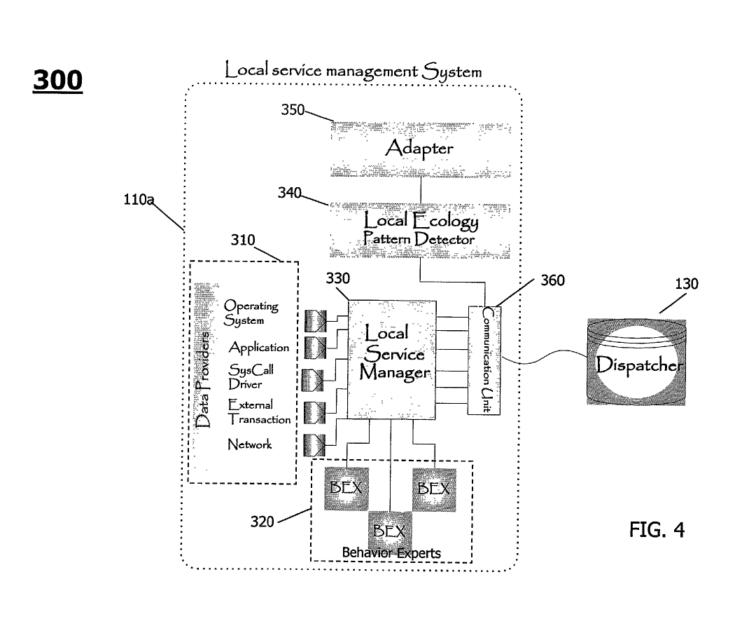

As described earlier, a behavior expert BeX 320 may be associated with one or more infrastructure component 240. This is illustrated in FIG. 4. To detect abnormal behavior in associated components, BeX bases its analysis on the observation data acquired by data providers 310. When abnormal behavior is detected, BeX 320 throw one or more events 460 to signal the abnormal behavior of underlying component.

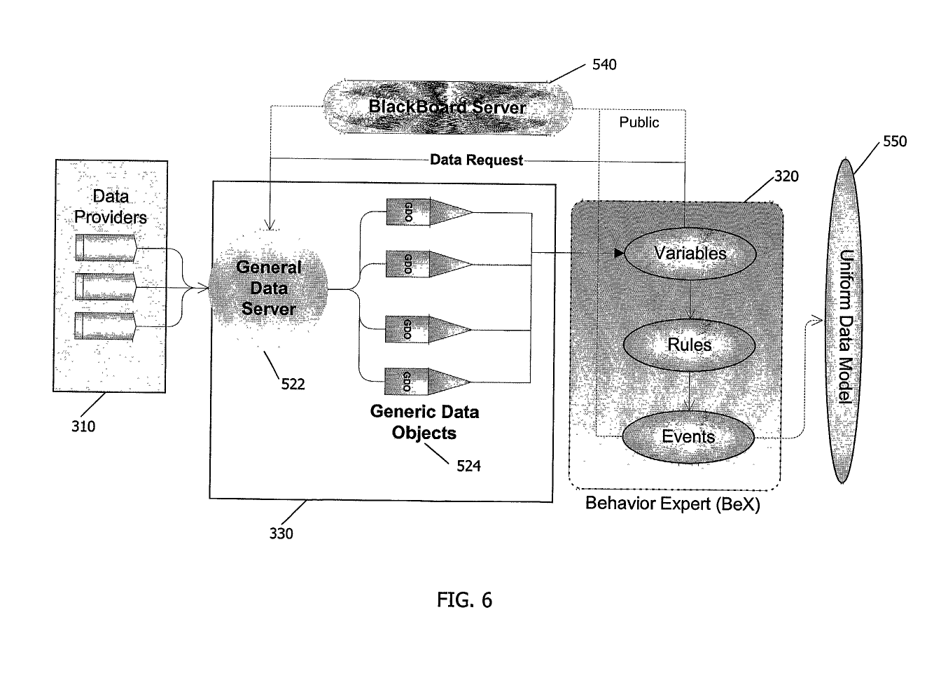

FIG. 6 describes in more detail how a BeX interacts with other parts of a local service management system. In FIG. 6, BeX 320 has internal variables, states, metric rules, and behavior rules. Observation data acquired by data providers is sent to a general data server 522 where the observation data is converted into generic data objects 524. Such generic data objects are accessed by BeXs to instantiate its internal variables. According to its metric rules, BeX 320 updates a set of states. The updated states may trigger firing a set of behavior rules, which may subsequently throw events 460 that are related to undesired behavior of the associated components.

In FIG. 6, events thrown by BeX 320 are posted on a blackboard server 540. The events that are shared on the blackboard are formatted using uniform data model 550. This format provides a standard interface or protocol for the communication among BeXs. The information posted on the blackboard server may also be sent back to general data server. So, in effect, BeXs may also act as a data provider. The events sent to blackboard server are public so that other BeXs can access them. This facilitates both forward and backward reasoning. BeX 320 may also request data from the general data server 522. For example, during backward reasoning, in order to check whether the condition of a particular rule is satisfied, a BeX may need to know the value of a particular variable. In this case, the BeX may request the data from the general data server 522.

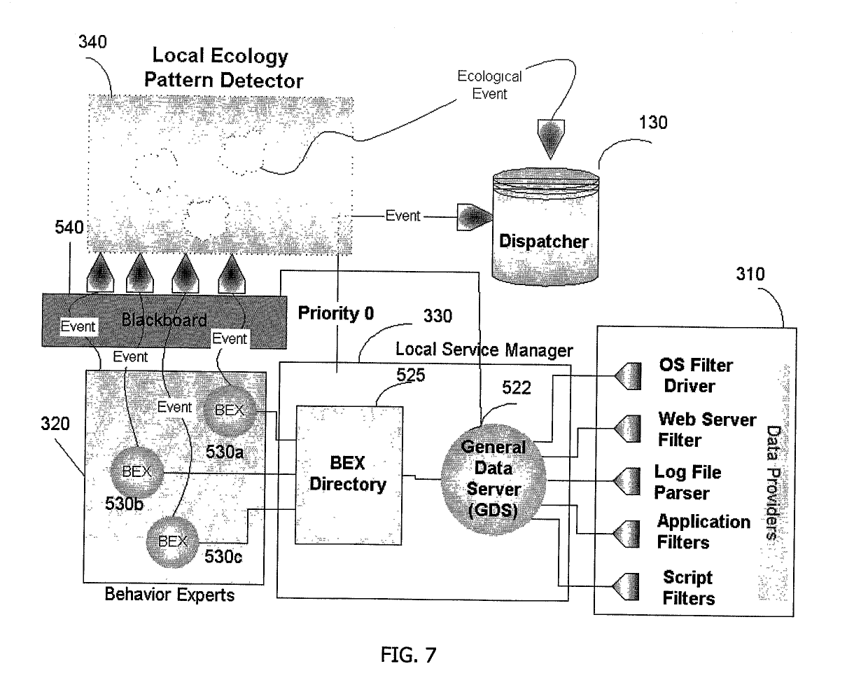

FIG. 7 shows a more detailed diagram of a local service management system. Data providers 310 send data to local service manager 330 where general data server 522 generates generic data objects. Local service manager also has a BeX directory where all the available BeXs are registered so that any BeX may check the availability of other BeXs for communication purposes. BeXs may also share their states via dependency relationships specified when BeXs are created.

Any abnormal behavior detected by a BeX may be reported in the form of events. Such events are posted on blackboard server 540 in uniform data model format. Events posted on blackboard server 540 may be accessed by other BeXs in 320 or by local ecology pattern detector 340. The local ecology pattern detector may also be implemented as a BeX whose function is to integrate the events reported by various BeXs to identify abnormal behavior at system level.

An event generated by a BeX may also be sent directly to dispatcher 130. Every event may be associated with a priority indicating the severity of the abnormal behavior. An event may be sent directly to dispatcher 130 if its priority is high. In other words, an event associated with a fatal problem in an eService infrastructure should be reported immediately to the highest management level. For example, if the operating system of a critical billing system for an eService is completely shut down, the detected event associated with this fatal problem needs to be immediately routed to the global eService management system so that prompt reaction can be taken.

An event that has lower priority may be sent to local ecology pattern detector. Examples of such events include low efficiency of a database. A minor misbehavior of an infrastructure component may or may not have a noticeable impact at eService level. Therefore, such events are sent to local ecology pattern detector 340 where a plurality of such events are absorbed and analyzed by an integration BeX to examine whether there is any alarming trend of system degradation. It is possible that even though individual BeXs detected minor faulty behavior in various components and none of them alone trigger an alarming event, a collection of minor abnormal behavior may cause significant impact on eService. The role of integration BeX is to identify such ecological abnormal behavior at system level. If local ecology pattern detector 340 detects ecological abnormal behavior, one or more ecological events are generated and sent to dispatcher 130. Ecological events are also formed in accordance with uniform data model.

The integration BeXs in ecology pattern detector 340 detect and monitor the local system according to the. knowledge of the business process model of the underlying eService. Such knowledge includes what role that the local system plays in the overall eService system, the criticality of the local system, and the correlation between local system's performance and the overall performance of the eService. Such knowledge is encoded in the integration BeXs to implement a business-centric eService management strategy.

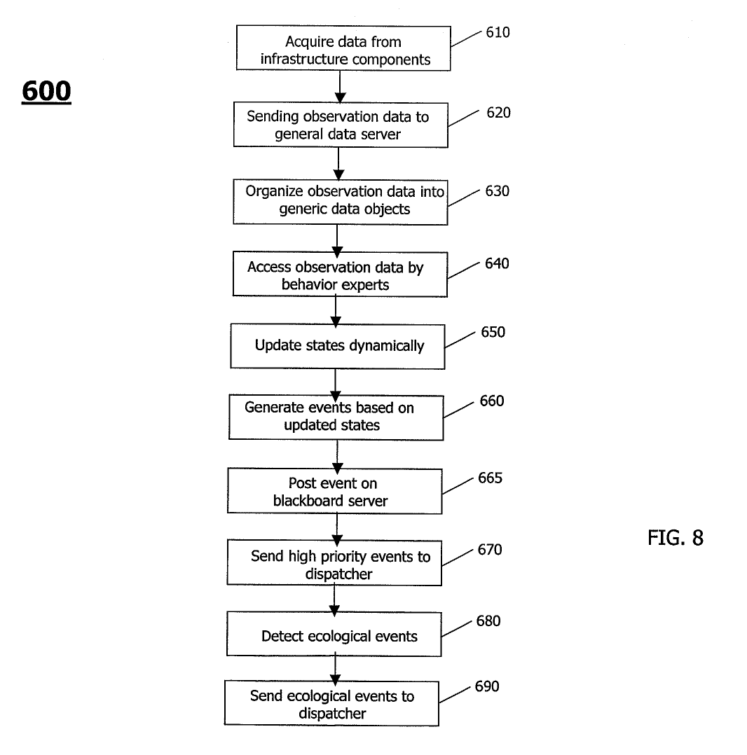

FIG. 8 shows an exemplary flowchart for a local service management system. Data providers from various infrastructure components at act 610 acquire observation data. Such data is sent to general data server at act 620 and converted into generic data objects at act 630. BeXs that are monitoring various infrastructure components access the observation data at act 640. Based on the observation data, BeXs analyze the behavior of the infrastructure components by examining its metric rules against observation data. Whenever a metric rules is satisfied, a BeX may update some of the states associated with the component. At act 650, BeXs dynamically update the states according to metric rules. Some of the newly updated states may be shared across different BeXs. At act 660, each BeX examines its behavior rules based on updated states. When the conditions in behavior rules are satisfied, it usually indicates that some undesired behavior of the infrastructure components is detected. The action of the fired behavior rules includes generating well-formulated events at act 660. Events formatted in uniform data model are posted at act 665 on blackboard server. Some of such events, if their priority is high, may be sent directly, at act 670, to dispatcher 130. Events posted on the blackboard are used by ecology pattern detector at act 680 to identify system level abnormal behavior. Any detected ecological event is sent at act 690 to dispatcher 130.

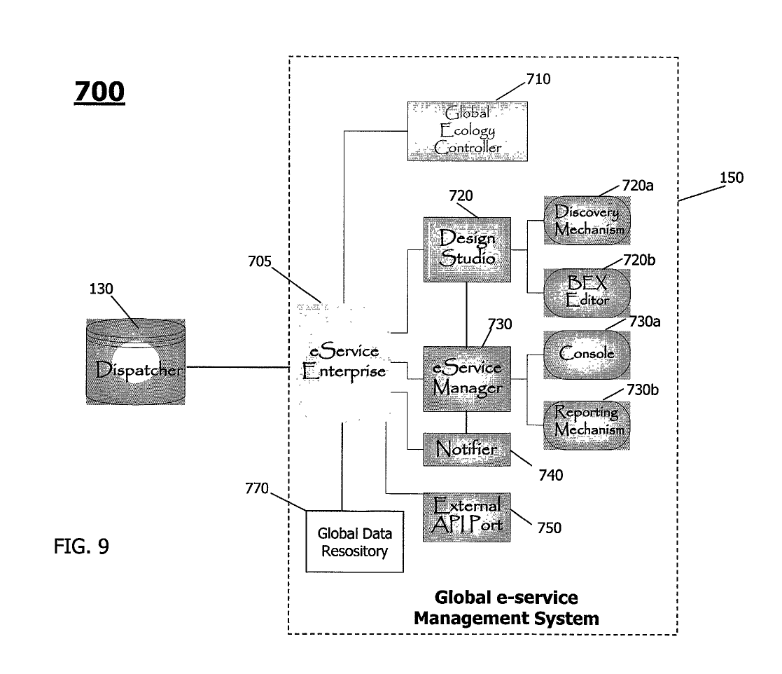

FIG. 9 shows an exemplary detailed block diagram of global eService management system 150. In FIG. 9, global eService management system is linked to local service management system 110 via dispatcher 130. There are other possible means to connect local service management system 110 and global eService management system 150. For example, communication unit 360 located in each local service management system is also capable of dispatching information directly to, for example, eService manager 730 located in global eService management system 150.

In FIG. 9, eService Enterprise 705 is a collection of eService level management tools, including a global ecology controller 710, a design studio 720, an eService manager 730, a notifier 740, an external API port 750, and a global data repository 770. Each of these eService level management tools may comprise more tools. For example, design studio 720 comprises, in the illustrated exemplary block diagram shown in FIG. 9, a discovery mechanism 720a that identifies applications on remote computer systems and a BeX editor 720b that allows a human manager to edit or generate new BeXs. eService manager 730 may access discovery mechanism 720a, BeX editor 720b, a console 730a, and a reporting mechanism 730b.

Global ecology controller 710 takes the events stored in the global data repository 770 as input and detects any abnormal behavior at eService level. The events stored in the global data repository 770 are the abnormal behavior reported from the BeXs that monitor different local systems or individual infrastructure components. Events stored in the global data repository 770 indicate the abnormality in parts of the eService infrastructure. Some are isolated misbehavior of individual components. For example, application software that performs on-line transaction may malfunction. If an isolated abnormal event directly affects the eService, the event may be sent immediately to dispatcher 130 with high priority. Some events stored in the global data repository 770 indicate ecological abnormal behavior at a system level. For example, due to overloading, the efficiency of an inventory system may drop to 80%. Ecological events may be detected by an integration BeX located in the ecology pattern detector of the inventory system. All abnormal events, isolated and ecological, are reported to dispatcher 130 so that global ecology controller can use them to estimate the overall performance of the eService.

Global ecology controller 710 translates reported abnormal events from local service management systems to overall quality of the eService based on the business process model. An integration BeX may be used to implement global ecology controller 710. This is illustrated in FIG. 10. Various BeXs attached to different infrastructure components monitor the behavior of the components and report any abnormal behavior. BeXs at this level may collaborate through sharing information via blackboard 540. Any event associated with individual components with high priority may be sent directly to dispatcher 130. All the abnormal behavior reported to blackboard 540 are reviewed and analyzed by local ecology pattern detector (an integration BeX at local system level). Ecological events associated with abnormal behavior of the local system are sent to dispatcher 130.

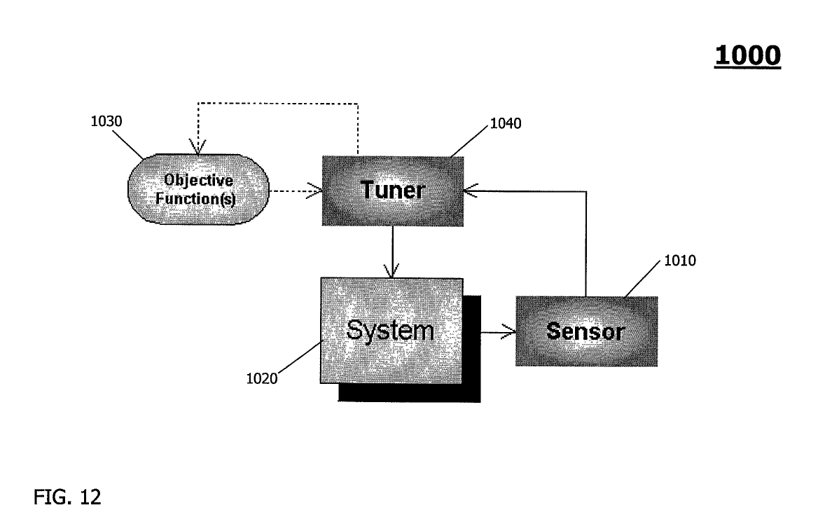

Reported abnormal behavior is reviewed, integrated, and analyzed by global ecology controller 710, implemented as an integration BeX in FIG. 10. In addition to computing an overall performance measure from reported abnormal behavior from various local systems and components, integration BeX 710 may initiate feedback control. This will be discussed later in referring to FIG. 12 to FIG. 14.

In FIG. 9, eService manager 730 facilitates all stages of an eService management system. For example, it stores any data related to the performance of the eService in global data repository 770. It may also facilitate both editing an application and editing a BeX through a design studio. Design studio 720a may provide a graphical user interface that allows a user to quickly compose or specify the infrastructure of an eService. For instance, its GUI may allow a user to simply pick and choose various infrastructure components to form a supporting eService infrastructure. For example, discovery mechanism 720a may perform automated search to identify the running applications on remote machines and list these applications as options to users. In the same GUI interface, a user may also be able to attach various plug-and-play BeXs to different infrastructure components by simply drag and drop.

eService manager 730 may also provide GUI interfaces that allow a user to interactively edit or generate BeXs. BeX editor 720b in FIG. 9, for example, allows a user to perform on-line adjustment to BeXs' rules. BeX editor 720b also facilitates the creation of new BeXs. The newly generated BeXs can be added to an existing eService management system.

eSevice manager 730 also facilitates the graphical visualization of eService management. Taking data from dispatcher 130, eService manager dispatched the data to reporting mechanism 730b that organizes the data describing the abnormal behavior of the infrastructure to fit certain visualization schemes and then displaying the monitoring results on console 730a. eService manager 730 may also facilitate various advanced user options on different schemes to visualize the monitoring results. For example, a user may choose to view the detailed status report of a particular malfunctioning infrastructure component and choose to view with all the supporting evidence associated with each of the reported status. In this case, once a user specifies the infrastructure component, eService manager 730 may pop up a mini-console on a GUI interface that displays only the status and the supporting evidence associated with the chosen component. Furthermore, eService manager 730 may also facilitate the request to view the monitoring data accumulated with time. In this case, measured performance on various components may be presented on the GUI as a time series or as a histogram.

eService manager 730 may further enable a special service that notifies relevant personnel about infrastructure performance. Notifier 740 is designed for that type of needs. For example, if a fatal error occurred in a critical component of an eService infrastructure and the person who is responsible for fixing the problem is immediately notified or called by notifier 740. The person to be notified may be located at a remote site. The notification may be activated based on different criteria.

eService Enterprise 705 may also provide APIs to the external world to expose detected abnormal events or status of the operating infrastructure. External API port 750 facilitates such needs. With external APIs, a third party may be able to access the eService management information generated by system 100. A user may construct customized visualization interface based on such accessed eService management information or integrate such information with other types of data for different purposes.

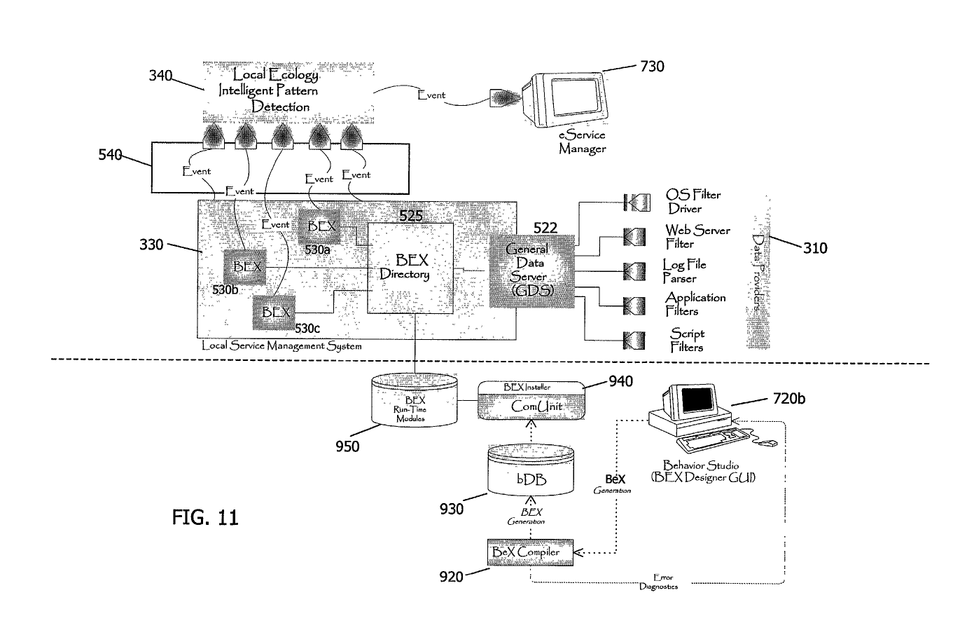

FIG. 11 shows the interaction between a local service management system, for example 110a, and the BeX editor 720b located in global eService management system 150. Each local service management system has a BeX directory where all the BeXs are registered. When the specifications of a new BeX is created in BeX editor 720b, it is compiled in BeX compiler 920 to generate an executable BeX. The executable BeX is then stored in a database 930. Whenever this new BeX is needed, it is retrieved from database 930 and installed, by a BeX installer 940, as a run-time module in a storage mechanism 950. As a run-time module, a BeX can then be registered in the BeX directory of a local service management system.

When the rules of a BeX is being revised on-line through BeX editor 720b (e.g., change the threshold in a metric rule), the updated BeX may be re-registered through the similar route as described for a new BeX.

Another aspect of BeXs is its adaptive reasoning capabilities, especially in the context of an eService management framework. When BeXs are used at different levels of eService management, they act as molecules, each carrying limited intelligence, yet together achieving high level of intelligence in a distributed fashion.

Adapter 350 in FIG. 4 is an adaptive feedback mechanism within a local service management system. Adaptive feedback control may be a top down process. It may be initiated by an integration BeX in local ecology pattern detector 340 down to individual BeXs attached to different infrastructure components. It may also be initiated by the integration BeX in global ecology controller 710 down to local ecology patter detector 340 and further down to individual BeXs.

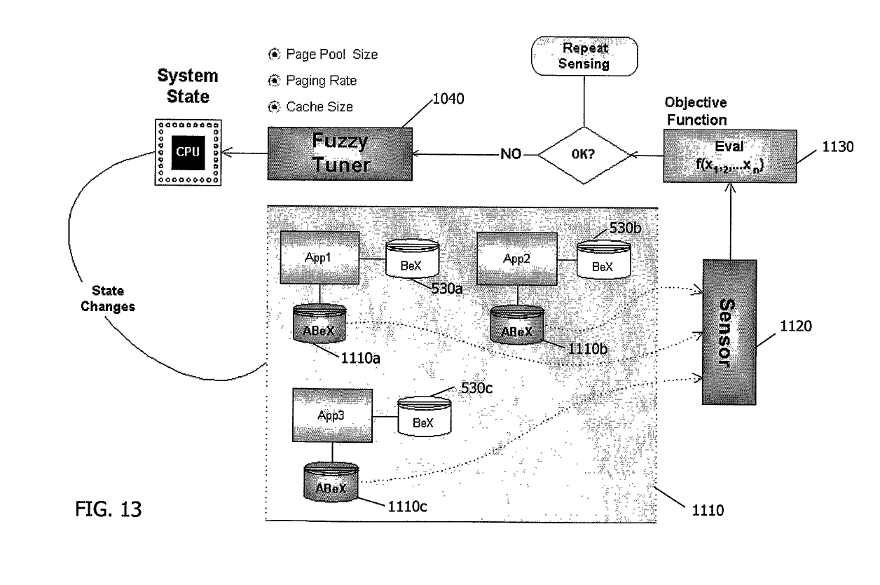

FIG. 12 shows a general block diagram of adaptive feedback. System 1020 represents a collection of BeXs. A sensor array 1010 may observe and record how system 1020 reacts to different situations in service management. Such sensor data is sent to a tuner1040. Tuner 1040 is equipped with a set of objective functions that are related to expected system performance. If the recorded data about system 1020 does not match with the objective functions, tuner 1040 initiates adaptive feedback control to tune system 1020. The tuning may be achieved by forcing the BeXs in system 1020 to revise the rules that are related to unsatisfactory performance. This process can be seen in more detail from FIG. 13.

In FIG. 13, system 1020 comprises, for example, three BeXs, 530a, 530b, and 530c, each of which is attached to an infrastructure component. In addition to these monitoring BeXs, a set of specially coded BeXs called adaptive-support BeXs or AbeXs, 1110a, 1110b, 1110c, are used for adaptive feedback control. Each of ABeXs comprises interconnected external (shared) state variables that can be accessed by sensor 1010. Data from sensor 1010 is evaluated by an evaluator 1030 against a set of objective functions. The objective functions may be multiple dimensioned. The evaluation may be performed by computing a set of Euclidean distance between the sensed states and the target states (specified by the objective functions). The distance is used to determine the adjustment to be made. Tuner 1040 sends adjustments back to the associated BeXs to update their internal states.

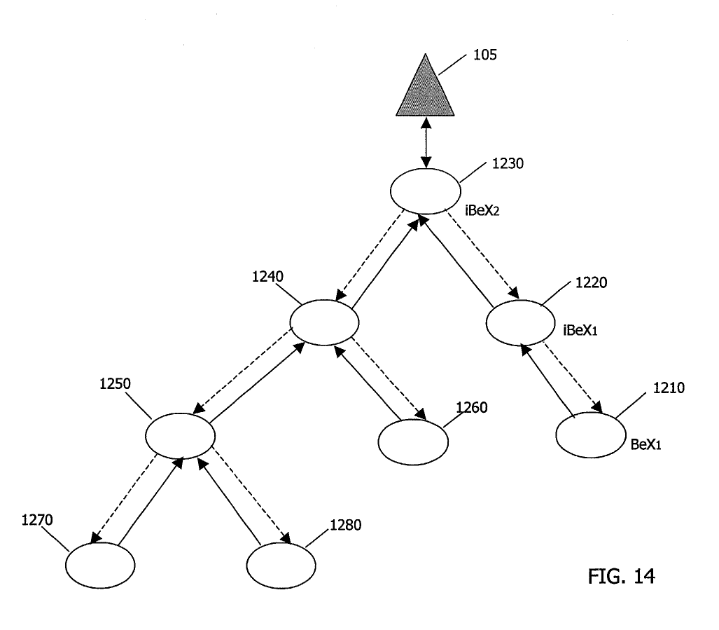

Sensor 1010, tuner 1040, and the evaluator 1040 may reside in a BeX where the adaptive feedback control is initiated. FIG. 14 shows an exemplary adaptive feedback control among a set of BeXs. In FIG. 14, BeX₁ 1210 is attached to an infrastructure component, for example, an application that computes the trend of a stock price. When the memory use of this particular application goes up to 35% on a local system, it may trigger a particular behavior rule. Since at component level, BeX₁ has no knowledge about the higher level business need for the capacity of the memory of this local system, it has no way to know what kind of impact this abnormal behavior will cause on the overall eService performance. So, the behavior rule associated with this stock price application may conservatively trigger an action to simply report this abnormal behavior to a higher level BeX.

Based on the behavior rule of BeX₁, this abnormal event is reported to an integration BeX 1220, located, for example, in local ecology pattern detector 340. The local integration BeX 1220 may still not have enough business process knowledge to estimate the severity of this particular abnormality with respect to the eService. So, it may further forward the event to a global integration BeX 1230, which may be located in global ecology controller 710. Since BeX 1230 sits at the eService level, it is equipped with the knowledge about the business process of eService 105. Based on such knowledge and the reported events from all parts of the eService infrastructure (BeXs 1240, 1250, 1260, 1270, and 1280), it may estimate or detect a significant performance degradation at eService level. By analyzing the reported abnormal events, BeX 1230 may decide that the major factor responsible for the overall performance degradation is the lack of memory space at the system where the stock price application is running. It may further identify that lack of memory is due to the fact (according to the event reported from BeX₁ 1210) that a particular application has used up a large chuck of memory on that system and caused shortage of the memory. In addition, it may recognize that 1210 and 1220 are the BeXs that are responsible for that particular application.

The unexpected performance degradation and the identified cause may trigger BeX 1230 to decide that adaptive feedback control is necessary. Since it is clear at this point that BeX₁, who is directly responsible for the faulty application, and all the BeXs (e.g., 120) that simply routed the information about the abnormal behavior of the faulty application fail to realize the severity of the misbehavior, iBeX 1230 initiates adaptive tuning by sending an updated rule to both BeX 1220 and BeX 1210. The rule is to be used to replace the conservative behavior rules that are previously used by both BeXs 1210 and 1220 regarding this particular behavior.

In the updated rule, it may explicitly indicate that if the memory usage of any single application exceeds 30%, then the application should be re-ranked with a much lower priority. It is also possible to simply instruct to kill such applications. The former strategy provides more space to conduct incremental learning. It is also possible for BeX 1230 to initiate a feedback control by sending a generic behavior rule to all the BeXs (1210, 1220, 1240, 1250, 1260, 1270, 1280) that restricts the use of any application at any time instance to maximum of 20% of total memory capacity.

Adaptive feedback control can be performed within different scopes. While the example shown in FIG. 14 is from the eService level all the way down to component level, it is also possible to initiate from local ecological level to component level or even among component level BeXs. It is flexible, dynamic, and learning based. It may be initiated when an unexpected performance degradation is due to the misjudgment from BeXs due to inexperience. It may be initiated because of other reasons. With the capability of self-adapting, the entire eSerive management system 100 is capable of continuous evolving, during its operation and based on accumulated experience, towards an optimal performance state.

What is claimed is:

1. A system for managing an e-service based on both the knowledge about the business process model of said e-service and the knowledge about the business infrastructure that supports said e-service, said system comprising:
a dispatcher for routing performance status information relevant to the business infrastructure;
at least one local service management system for ensuring the service quality of different local infrastructure of said business infrastructure, generating and routing performance status information relevant to said local infrastructure to said dispatcher; and
a global e-service management system for ensuring the service quality of said e-service by managing the business infrastructure based on the business process model of said e-service and the performance status information routed through said dispatcher to a global data repository.

2. The system according to claim 1, wherein said global data repository includes a database implemented on a computer-accessible medium.

3. The system according to claim 2, wherein said computer-accessible medium includes hard disk.

4. The system according to claim 1, wherein each said local infrastructure includes at least one of services, components, and resources.

5. The system according to claim 1, wherein said global e-service management further comprises:
a global ecology controller for estimating overall performance of said business infrastructure; and
a global e-service manager for describing and reporting said performance status information.

6. The system according to claim 5, wherein said global e-service manager further comprises:
a console for displaying said performance status information; and
a report mechanism for organizing performance status information into a graphical representation and then displaying said graphical representation of the performance status information on said console.

7. The system according to claim 5, further comprising:
a design studio for designing new functionality of said e-service management;
an notification mechanism for notifying relevant parties regarding infrastructure performance; and
an export for providing external application programming interfaces.

8. The system according to claim 7, wherein said design studio further comprises:
a discovery mechanism for identifying running application on remote computer systems; and
an editor for manual updating and designing a behavior expert.

9. The system according to claim 1, wherein each of said local service management further comprises:
a local service manager for ensuring the service quality of a local infrastructure of said business infrastructure;
at least one data provider for providing observation data acquired from different components of said local infrastructure;
at least one behavior expert for detecting abnormal events related to said different components of said local infrastructure based on said observation data; and
a local ecology detector for detecting abnormal ecological event of the local infrastructure based on said abnormal events, detected by said at least one behavior expert.

10. The system according to claim 9, wherein said local service manager comprises:
a general data server for organizing said observation data from said at least one data provider into generic data objects; and
a blackboard server for hosting abnormal events that are detected, posted, and accessed by said at least one behavior expert for asynchronous communication among said at least one behavior expert.

11. The system according to claim 9, wherein said at least one data provider includes at least one of services, components, resources, and behavior experts.

12. The system according to claim 4 and claim 11, wherein said components include a web server, a database server, an application server, an iNet service, and a load balancer.

13. The system according to claim 4 and claim 11, wherein said resources include an operating system, an application, a system call driver, an external transaction, and a network.

14. The system according to claim 9, further comprising an adapter for tuning said at least one behavior expert according to the feedback from normal service operations performed on said business infrastructure.

15. The system according to claim 14, wherein said adapter includes:
a storage for storing at least one objective function describing desired service behavior of said local infrastructure;
at least one sensor connected to said at least one behavior expert associated with said local infrastructure to record the states of said at least one behavior expert;
an evaluator to evaluate the discrepancy between said at least one objective function and said states recorded by said at least one sensor; and
an adaptive tuner for adaptively updating said states based on said discrepancy.

16. A method for managing an e-service based on both the knowledge about the business process model of said e-service and the knowledge about the business infrastructure that supports said e-service, said method comprising:
generating performance status information related to different local infrastructure of said business infrastructure by at least one local service management system that ensures service quality of said different local infrastructure based on the business process model and the knowledge about the local infrastructure;
routing said performance status information to a dispatcher;
sending said performance status information by said dispatcher to a global data repository; and
managing said business infrastructure by a global e-service management system that ensures service quality of said e-service based on said performance status information and the business process model.

17. The method according to claim 16, wherein said global data repository includes a database implemented on a computer-accessible medium.

18. The method according to claim 17, wherein said computer-accessible medium includes hard disk.

19. The method according to claim 16, wherein each said local infrastructure includes at least one of services, components, and resources.

20. The method according to claim 16, wherein said generating by at least one local service management comprises:
accessing observation data, by at least one behavior expert, from a general data server;
detecting abnormal events by said at least one behavior expert, each of said at least one behavior expert ensuring the quality of a different logical part of a local infrastructure based on said observation data, the business process model for said e-service, and the knowledge about the logical part;
estimating the performance of said local infrastructure, by a local ecology detector, by detecting abnormal ecological events based on said abnormal events and said business process model to generate said performance status information.

21. The method according to claim 20, further comprising:
receiving said observation data, by said general data server, from at least one data provider; and
posting said abnormal events, by said at least one behavior expert, on a blackboard server.

22. The method according to claim 21, further comprising:
acquiring the states of said at least one behavior expert via at least one sensors;
retrieving at least one objective function describing desired service behavior of said local infrastructure;
analyzing the discrepancy between said states and said at least one objective function; and
adapting by updating said states of said at least one behavior expert based on said discrepancy.

23. The method according to claim 21, wherein said at least one data provider includes a service, a component, a resource, and a behavior expert.

24. The method according to claim 20, wherein said estimating by a local ecology detector detects said abnormal ecological events using at least one of statistics, frequency, and fuzzy logic method.

25. The method according to claim 16, wherein said managing comprises:
detecting overall performance of said business infrastructure, by a global ecology controller, based on said performance status information routed through said dispatcher and stored in the global data repository; and
reporting said performance status information, by a global e-service manager.

26. The method according to claim 25, wherein said reporting further comprises:
organizing performance status information into a graphical representation; and
displaying said graphical representation on a display device.

27. The method according to claim 25, further comprising:
implementing new functionality for said e-service management;
notifying said performance status information; and
providing external application programming interfaces.

28. The method according to claim 27, wherein said implementing new functionality comprises:
a discovery mechanism for identifying applications running on remote computer systems; and
updating the rules of a behavior expert; and
designing a new behavior expert.

29. The method as in any one of claims 16 to claim 28, wherein each of said behavior expert:
monitoring at least one part of said business infrastructure;
learning the impact of the behavior of said at least one part on said e-service; and
managing said at least one part based on the knowledge about said at least one part and the knowledge learned through said learning.

30. A computer-readable medium, encoded with a program for managing an e-service based on both the knowledge about the business process model of said e-service and the knowledge about the business infrastructure that supports said e-service, said program comprising:
generating performance status information related to different local infrastructure of said business infrastructure by at least one local service management that ensures service quality of said different local infrastructure based on the business process model and the knowledge about the local infrastructure;
routing said performance status information to a dispatcher;
sending said performance status information by said dispatcher to a global data repository; and
managing said business infrastructure by a global e-service management that ensures service quality of said e-service based on said performance status information and the business process model.

31. The computer-readable medium according to claim 30, wherein each said local infrastructure includes at least one of services, components, and resources.

32. The computer-readable medium according to claim 30, wherein said generating by at least one local service management comprises:
accessing observation data, by at least one behavior expert, from a general data server;
detecting abnormal events by said at least one behavior expert, each of said at least one behavior expert ensuring the quality of a different logical part of a local infrastructure based on said observation data, the business process model for said e-service, and the knowledge about the logical part;
estimating the performance of said local infrastructure, by a local ecology detector, by detecting abnormal ecological events based on said abnormal events and said business process model to generate said performance status information.

33. The computer-readable medium according to claim 32, said program further comprising:
receiving said observation data, by said general data server, from at least one data provider; and
posting said abnormal events, by said at least one behavior expert, on a blackboard server.

34. The computer-readable medium according to claim 33, said program further comprising:
acquiring operational information of said local infrastructure via at least one sensors;
retrieving at least one objective function describing desired service behavior of said local infrastructure; and
adapting an exception table describing undesired service behavior of said local infrastructure based on the operational information, acquired by said acquiring, and said at least one objective function.

35. The computer-readable medium according to claim 30, wherein said managing comprises:
detecting overall performance of said business infrastructure, by a global ecology controller, based on said performance status information routed through said dispatcher and stored in the global data repository; and
reporting said performance status information, by a global e-service manager.

36. The computer-readable medium according to claim 35, wherein said reporting further comprises:
organizing performance status information into a graphical representation; and
displaying said graphical representation on a display device.

37. The computer-readable medium according to claim 35, said program further comprising:
implementing new functionality for said e-service management;
notifying said performance status information; and
providing external application programming interfaces.

38. The computer-readable medium according to claim 37, wherein said implementing new functionality comprises:
a discovery mechanism for identifying applications running on remote computer systems;
updating the rules of a behavior expert; and
designing a new behavior expert.

39. The computer-readable medium as in any one of claim 30 to claim 38, wherein each of said behavior expert:
monitoring at least one part of said business infrastructure;
learning the impact of the behavior of said at least one part on said eservice; and
managing said at least one part based on the knowledge about said at least one part and the knowledge learned through said learning.
